(19) United States
(12) Patent Application Publication
(10) Pub. No.: US 2016/0125081 A1
(43) Pub. Date: May 5, 2016

(54) WEB CRAWLING

(71) Applicant: Yahoo! Inc., Sunnyvale, CA (US)

(72) Inventors: Roi Blanco, Barcelona (ES); Peter Mika, Barcelona (ES); Robert Meusel, Mannheim (DE)

(21) Appl. No.: 14/530,558

(22) Filed: Oct. 31, 2014

(51) Int. Cl. G06F 17/30

(52) U.S. Cl. CPC G06F 17/30864; G06F 17/30598; G06F 17/30896

(57) ABSTRACT

Briefly, embodiments disclosed herein may relate to Web crawling, and more particularly may relate to Web crawling for structured content, for example.

### BACKGROUND

1. Field

Subject matter disclosed herein may relate to Web crawling.

2. Information

With networks, such as the Internet, gaining popularity, and with a vast multitude of content, such as pages, other electronic documents, other media content and/or applications (hereinafter ‘digital content’), becoming available to users, such as via the World Wide Web (hereinafter ‘Web’), it may be desirable to provide more efficient and/or more streamlined approaches to gather, organize and/or display content, such as digital content, that may be desired by and/or useful to a user, for example. Internet-type business entities, such as Yahoo!, for example, may provide a wide range of content, such as digital content, that may be made available to users, such as via the Web. In some circumstances, challenges may be faced in extracting content, such as from Web pages, especially content-rich Web pages, so that it may be accessed, including via search engines and/or social media sites, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is an illustration of an example process for Web crawling, according to an embodiment.

FIG. 2 is an illustration of another example process for Web crawling, according to an embodiment.

FIG. 3 is a schematic diagram illustrating an example process for focused Web crawling, according to an embodiment.

FIG. 4 is a schematic diagram illustrating an example computing device in accordance with an embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which apportions of a computational problem may be allocated among computing devices, including one or more clients and one or more servers, via a computing and/or communications network, for example. A network may comprise two or more network devices and/or may couple network devices so that signal communications, such as in the form of signal packets and/or frames, for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computer and/or machine readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be compliant and/or compatible with differing protocols, such as computing and/or communication protocols (e.g., network protocols), may interoperate within a larger network. In this context, the term sub-network refers to a portion and/or part of a network. Sub-networks may also comprise links, such as physical links, connecting and/or coupling nodes to transmit signal packets and/or frames between devices of particular nodes including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting network communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate noes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but such devices outside the private network may not necessarily direct inbound network communications to devices included in the private network.

The Internet refers to a decentralized global network of interoperable networks that comply with the Internet Protocol (IP). It is noted that there are several versions of the Internet Protocol. Here, the term Internet Protocol or IP is intended to refer to any version, now known and/or later developed. The Internet includes local area networks (LANs), wide area networks (WANs), wireless networks, and/or long haul public networks that, for example, may allow signal packets and/or frames to be communicated between LANs. The term world wide web (WWW or web) and/or similar terms may also be used, although it refers to a sub-portion of the Internet that complies with the Hypertext Transfer Protocol or HTTP. For example, network devices may engage in an HTTP session through an exchange of Internet signal packets and/or frames. It is noted that there are several versions of the Hypertext Transfer Protocol. Here, the term Hypertext Transfer Protocol or HTTP is intended to refer to any version, now known and/or later developed. It is likewise noted that in various places in this document substitution of the term Internet with the term world wide web may be made without a significant departure in meaning and may, therefore, not be inappropriate in that the statement would remain correct with such a substitution.

Although claimed subject matter is not in particular limited in scope to the Internet or to the web, it may without limitation provide a useful example of an embodiment for purposes of illustration. As indicated, the Internet may comprise a worldwide system of interoperable networks, including devices within those networks. The Internet has evolved to a public, self-sustaining facility that may be accessible to tens of millions of people or more worldwide. Also, in an embodiment, and as mentioned above, the terms “WWW” and/or “web” refer to a sub-portion of the Internet that complies with the Hypertext Transfer Protocol or HTTP. The web, therefore, in this context, may comprise an Internet service that organizes stored content, such as, for example, text, images, video, etc., through the use of hypermedia, for example. A HyperText Markup Language (“HTML”), for example, may be utilized to specify content and/or format of hypermedia type content, such as in the form of a file or an “electronic document,” such as a web page, for example. An Extensible Markup Language (“XML”) may also be utilized to specify content and/or format of hypermedia type content, such as in the form of a file or an “electronic document,” such as a web page, in an embodiment. Of course, HTML and XML are merely example languages provided as illustrations and, furthermore, HTML and/or XML is intended to refer to any version, now known and/or later developed. Likewise, claimed subject matter is not intended to be limited to examples provided as illustrations, of course.

Although claimed subject matter is not intended to be limited in scope to the Internet or to the Web, it may without limitation provide a useful example of an embodiment for purposes of illustration. As indicated, the Internet may comprise a worldwide system of interoperable networks, including devices within those networks. The Internet has evolved to a public, self-sustaining facility that may be accessible to tens of millions of people or more worldwide. Also, in an embodiment, and as mentioned above, the terms “WWW” and/or “Web” refer to a sub-portion of the Internet that complies with versions of the Hypertext Transfer Protocol or HTTP. The Web, therefore, in this context, comprises an Internet service that organizes stored content, such as, for example, text, images, video, etc., through use of hypermedia, for example. A HyperText Markup Language (“HTML”), for example, may be utilized to specify content and/or a format of hypermedia type content, such as in the form of a file or an “electronic document,” such as a Web page, for example. Versions of an Extensible Markup Language (XML) may also be utilized to specify content and/or a format of hypermedia type content, such as in the form of a file or an “electronic document,” such as a Web page, in an embodiment. The terms ‘HTML’ and ‘XML’ are intended to refer to any now known and/or later developed version of these languages, respectively. Likewise, claimed subject matter, of course, includes content that complies with and/or is compatible with such languages, in an embodiment. Of course, HTML and XML are merely examples provided as illustrations. Claimed subject matter is not intended to be limited to examples provided as illustrations, of course.

As used herein, the term “Web site” or similar terms refers to a collection of related Web pages. Also as used herein, “Web page” and/or similar terms refers to any electronic file or electronic document, such as may be accessible via a network, including by specifying a URL for accessibility via the Web, in an example embodiment. As alluded to above, in one or more embodiments, a Web page may comprise content coded using one or more languages, such as, for example, markup languages, including HTML and/or XML, although claimed subject matter is not limited in scope in this respect. Also, in one or more embodiments, application developers may write code in the form of JavaScript, for example, to provide content to populate one or more templates, such as for an application. The term ‘JavaScript’ is intended to refer to any now known and/or later developed version of this programming language. However, JavaScript is merely an example programming language. As was mentioned, claimed subject matter is not limited to examples or illustrations.

As used herein, the terms “entry”, “electronic entry”, “document”, “electronic document”, “content”, “digital content”, “item”, and/or similar terms are meant to refer to signals and/or states in a physical format, such as a digital signal and/or digital state format, e.g., that may be perceived by a user if displayed, played and/or otherwise executed by a device, such as a digital device, including, for example, a computing device, but otherwise might not necessarily be perceivable by humans (e.g., in a digital format). Likewise, in this context, content (e.g., digital content) provided to a user in a form so that the user is able to perceive the underlying content itself (e.g., hear audio or see images, as examples) is referred to, with respect to the user, as ‘consuming’ content, ‘consumption’ of content, ‘consumable’ content and/or similar terms. For one or more embodiments, an electronic document may comprise a Web page coded in a markup language, such as, for example, HTML (hypertext markup language). In another embodiment, an electronic document may comprise a portion or a region of a Web page. However, claimed subject matter is not limited in these respects. Also, for one or more embodiments, an electronic document and/or electronic entry may comprise a number of components. Components in one or more embodiments may comprise text, for example, capable of being physically displayed on a Web page. Also, for one or more embodiments, components may comprise a graphical object, such as, for example, an image, such as a digital image, and/or sub-objects, such as attributes thereof, which, again, is capable of being physically displayed. In an embodiment, content may comprise, for example, text, images, audio, video, and/or other types of electronic documents and/or portions thereof, for example.

Signal packets and/or frames, also referred to as signal packet transmissions and/or signal frame transmissions, and may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet and/or frame may, for example, be communicated via a communication channel and/or a communication path comprising a portion of the Internet, from a site via an access node coupled to the Internet. Likewise, a signal packet and/or frame may be forwarded via network nodes to a target site coupled to a local network, for example. A signal packet and/or frame communicated via the Internet, for example, may be routed via a path comprising one or more gateways, servers, etc. that may, for example, route a signal packet and/or frame in accordance with a target and/or destination address and availability of a network path of network nodes to the target and/or destination address. Although the Internet comprises a network of interoperable networks, not all of those interoperable networks are necessarily available and/or accessible to the public.

In particular implementations, a network protocol for communicating between devices may be characterized, at least in part, substantially in accordance with a layered description, such as the so-called Open Systems Interconnection (OSI) seven layer model. Although physically connecting a network via a hardware bridge is done, a hardware bridge may not, by itself, typically include a capability of interoperability via higher level layers of a network protocol. A network protocol refers to a set of signaling conventions for computing and/or communications between and/or among devices in a network, typically network devices; for example, devices that substantially comply with the protocol and/or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance and/or substantial compatibility.

Typically, a network protocol, such as protocols characterized substantially in accordance with the aforementioned OSI model, has several layers. These layers may be referred to here as a network stack. Various types of network transmissions may occur across various layers. A lowest level layer in a network stack, such as the so-called physical layer, may characterize how symbols (e.g., bits and/or bytes) are transmitted as one or more signals over a physical medium (e.g., twisted pair copper wire, coaxial cable, fiber optic cable, wireless air interface, combinations thereof, etc.). Progressing to higher-level layers in a network protocol stack, additional operations may be available by initiating network transmissions that are compatible and/or compliant with a particular network protocol at these higher-level layers. Therefore, for example, a hardware bridge, by itself, may be unable to forward signal packets to a destination device since transmission of signal packets characterized at a higher-layer of a network stack may not be supported by a hardware bridge. Although higher-level layers of a network protocol may, for example, affect device permissions, user permissions, etc., a hardware bridge, for example, may typically provide little user control, such as for higher-level layer operations.

A virtual private network (VPN) may enable a remote device to more securely (e.g., more privately) communicate via a local network. A router may allow network communications in the form of network transmissions (e.g., signal packets and/or frames), for example, to occur from a remote device to a VPN server on a local network. A remote device may be authenticated and a VPN server, for example, may create a special route between a local network and the remote device through an intervening router. However, a route may be generated and/or also regenerate if the remote device is power cycled, for example. Also, a VPN typically may affect a single remote device, for example, in some situations.

A network may be very large, such as comprising thousands of nodes, millions of nodes, billions of nodes, or more, as examples.

As mentioned, with networks, such as the Internet, gaining popularity, and with large amounts of content, such as pages, other electronic documents, other media content and/or applications (hereinafter ‘digital content’), becoming available to users, such as via the World Wide Web (hereinafter ‘Web’), it may be desirable to provide more efficient and/or more streamlined approaches to gather, organize and/or display content, such as digital content, that may be desired by and/or useful to a user, for example. Internet-type business entities, such as Yahoo!, for example, may provide a wide range of content, such as digital content, that may be made available to users, such as via the Web. In some circumstances, challenges may be faced in extracting content, such as from Web pages, especially content-rich Web pages, so that it may be accessed, including via search engines and/or social media sites, for example.

Increasingly, markup languages for semi-structured and/or structured content (collectively referred to throughout this document as ‘structured content’) are being utilized, such as by large consumers and/or publishers of Web content. In this context, the term ‘structured content’ (e.g., semi-structured and/or structured content) and/or similar terms refer to digital content in which a portion thereof is expressed in an electronic document, such as a Web pager, using a markup language format. Several Web search engines, such as Bing, Google, Yahoo!, and/or Yandex, have jointly developed a mark-up language, as a non-limiting example, referred to here as the “schema.org” vocabulary. Some common types of digital objects that may appear on various Web pages may, thus, exhibit a common format. Example types of digital objects that may be accommodated by the schema.org vocabulary may include videos, reviews, recipes, addresses, personal profiles, product descriptions, and so forth.

Search engines may exploit markup-type structured content to provide richer search experiences. Social media sites, such as Facebook, Twitter, and/or Pinterest, for example, may utilize structured content to provide richer displays of content to be shared among users. In some circumstances, however, challenges may be faced in extracting content, such as rich and/or structured content, from Web pages that may be utilized by search engines and/or social media sites, for example.

In an embodiment, a focused Web crawler may crawl for content that includes structured content. In an embodiment, a focused Web crawler for structured content may be designed, at least in part, with a goal of seeking structured content of higher value, for example as expressed in a particular markup language such as schema.org, and/or containing particular types of objects such as videos, and/or determined to be more complete or accurate by some measure of content quality as opposed to trying to increase the number of Web pages crawled, as may be the goal with conventional Web crawlers. Of course, an embodiment may also seek to accomplish both. Also, in an embodiment, structured content may comprise semantic content. As used herein, the term “semantic content” may refer to digital content intended to convey, at least in part, the meaning of other digital content, such as other structured content, in an embodiment. For example, semantic content may describe, at least in part, structured content stored at a Web page, in an embodiment.

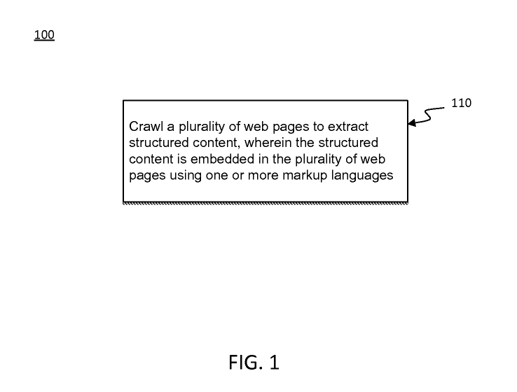

FIG. 1 is an illustration of an example embodiment of a process to crawl a plurality of Web pages. An embodiment of a Web crawler may crawl a plurality of Web pages to extract structured content. See, for example, block 110 of FIG. 1. As also depicted at block 110, structured content may be embedded in a plurality of Web pages utilizing one or more markup languages. Of course, although FIG. 1 depicts a single block, e.g., 110, other embodiments may include more than block 110.

In an embodiment, online classification and/or bandit-type page selection operations may be combined in an example crawling process to select (e.g., locate) and extract structured content from Web pages. As used herein, the term “online classification” may refer to a classification technique and/or process that may adapt itself over time through learning (e.g., machine learning), and/or that may be utilized without initial training sets, in an embodiment. Also, as used herein, the term “bandit-type” page selection may refer to a technique and/or process for selecting a Web page and/or other digital content that may have competing and/or complementary goals of improving the value of digital content to be extracted from a current set of Web pages and/or exploring additional Web pages for potentially more valuable digital content to extract, in an embodiment. In an embodiment, utilization of online classification of Web pages as part of an example Web crawling process may help overcome an issue of lack of a-priori knowledge about whether identified Web pages contain structured content. Also, in an embodiment, utilization of bandit-type Web page selection as part of an example Web crawling process may help address an issue of exploitation versus exploration, thereby allowing an example Web crawler to perform ‘random walks’ and, therefore, fetch Web pages potentially of more value based at least on a measure of value than those already discovered.

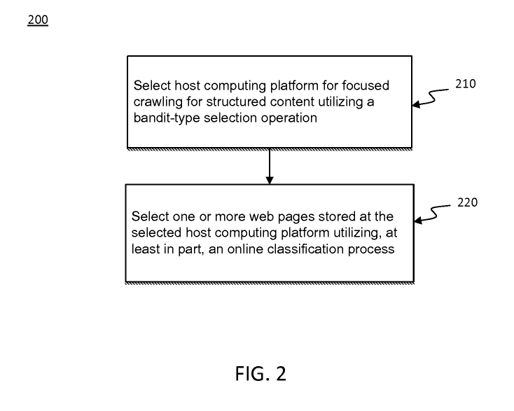

FIG. 2 is an illustration of an example process for Web crawling, according to an embodiment. At block 210, a host computing device, such as a computing device hosting a plurality of Web pages, may be selected for focused crawling for structured content. In an embodiment, a bandit-type selection operation may be utilized at least in part to select a host computing device. Also, in an embodiment, one or more Web pages, such as one or more Web pages stored at a host computing device, may be selected utilizing, at least in part, an online classification process, as depicted at block 220. Of course, embodiments in accordance with claimed subject matter may include all of blocks 210-220, fewer than blocks 210-220, or more than blocks 210-220. Also, the order of blocks 210-220 as depicted in FIG. 2 is merely an example order, and claimed subject matter is not limited in scope in these respects.

As mentioned, in one or more embodiments, an online classifier process may be utilized as part of an example Web crawling operation to select (e.g., locate) one or more Web pages for structured content extraction. In an embodiment, an “online” classifier may differ from conventional, or offline, classifiers in that an online classifier may adapt itself over time through learning (e.g., machine learning). Also, in an embodiment, online classifiers may differ from offline or conventional classifiers in that an online classifier may be utilized without training sets. For example, in an embodiment, an example online classifier may attempt to extract one or more features from a Web page which the classifier may utilize to predict whether or not a particular page contains structured content. In one or more embodiments, one or more Web page features may be gleaned, at least partly, from one or more sources. In an embodiment, one or more features may be available before downloading and/or parsing a Web page. For example, Web page features may be gleaned, at least in part, from a Web page's Uniform Resource Locator (URL), where applicable. In an embodiment, natural language techniques may be utilized to transform a URL into a feature vector, for example. Also, in an embodiment, Web page features may be gleaned, at least in part, from content related to one or more parent pages of a Web page. For example, one or more parent Web pages may have been previously downloaded, and relevance for a specified objective may already be known, thus aiding in classification of a child Web page. An additional source of Web page features may include content derived from sibling Web pages, for example.

In an embodiment, a URL may be partitioned into a plurality of tokens that may represent features of a Web page. Also, because a Web crawler may not necessarily adequately handle a full range of different tokens that may be extracted from a URL, it may be difficult to specify a feature set for online learning. This situation may be helped at least in part by employing a hash operating and mapping tokens onto a specified feature space.

For example, a list of URL tokens may be received at a Web crawler, and a feature vector V with length k may be created for a new Web page. Individual components of feature vector V may be initialized with “0” values, for example. Individual tokens t may be mapped within a list to xₜε[0 . . . (k−1)] utilizing a hash-operating described below in expression (1), wherein n represents count of characters of t, k represents count of selected hashes and t[i] represents a value for a character at position i. A corresponding position within feature vector V may be updated substantially according to V(xₜ)←1.

$${x}_{t} = \vert ⌊ \frac{{\sum }_{i = 0}^{i < n} t [ i ] \cdot {31}^{n - i + 1}}{k} ⌋ \vert \qquad ( 1 )$$

In one or more embodiments, selection of features and/or classification, such as online classification, may have influence at least partially on Web page selection performance. Example embodiments may utilize various combinations of features, classifiers and/or parameter configurations (e.g., number of hashes, classifier dependent settings, etc.). For example, embodiments may utilize a Naïve Bayes and/or a Hoeffding Trees online classification processes, although claimed subject matter is not limited in scope in this respect. In an embodiment, as a non-limiting example, an amount, such as 10,000 hashes, may be utilized with a Naïve Bayes classification process to produce results, although, again, claimed subject matter is not limited in scope in to these example classification processes.

As also mentioned above, a bandit-type selection technique may be utilized by a focused Web crawler for structured content to estimate relevance of a group of Web pages for a given host target, and selection of a host may be based, at least in part, on expected relevance and/or other measures of a group of Web pages.

In an embodiment, an example bandit-type selection may operate as follows: at individual rounds t there may exist a set of actions A (also referred to as a set of “arms”), and an action (arm) a may be selected aₜεA; a reward r_{a,t} may be observed (e.g., measured), and the example bandit-type selection may operate with a specified goal of increasing a cumulative reward over time. In an embodiment, an example bandit-type selection operation may improve its arm-selection strategy over time as new observations are obtained. To increase a current reward (exploitation), an action may be selected so as to improve E(r|A)=∫E(r|a,θ)p(θ|D)dθ, wherein D represents a past set of observations (a, rₐ). Also, in an embodiment, to achieve a specifiable exploration/exploitation balance setting, it may be desirable to randomly select an action a in accordance with an action's probability of being Bayes-type substantially in according to expression (2):

∫I[(r|a,θ)=max_{a′}E(r|a′,θ)]ₚ(θ|D)dθ (2)

wherein I represents an indicator operation. In an embodiment, to approximate the foregoing expression (2), a random parameter θ may be drawn at individual rounds t. Also, in an embodiment, a λ-greedy process may be utilized, wherein for individual trials, an average payoff for individual actions a may be estimated. With a probability of 1−λ, for example, an action may be selected at random, and/or with a probability λ, an action may be selected with a higher payoff estimate \hat{θ}_{t,a}. In the limit, in theory, individual arms may be tried infinitely often and an estimate \hat{θ}_{t,a} may converge to a value θₐ.

In another embodiment, a decaying factor, such as λₜ, may be utilized. For example, a decaying λₜ may approach 0 faster in a successive iteration. In other embodiments, a linear decaying factor,

$${λ}_{t} = λ \cdot \frac{m}{t + m} ,$$

wherein m comprises a constant value, may be employed. Likewise, a host of other approaches to implementing a decaying factor may be employed in alternate embodiments.

As mentioned, a bandit-type approach may be utilized to make a selection of a host to be crawled. Approaches, including those described herein to provide non-limiting illustrations, may be utilized due at least in part to structured content markup decisions tending to be made on a per-host basis in at least some cases. In an embodiment, individual hosts may be represented by a bandit (e.g., bandit-type) that comprises a measure of value of discovered pages for a host. Any of a number of techniques to calculate value for a host and to estimate relevance of a target host may be employed for one or more embodiments. In an embodiment, to select an action in the context presented above, as an example, selecting a host, which at a given point in time has a relatively high expected and/or estimated value, may be employed. Also, in an embodiment, an online classifier may be employed to select one or more Web pages from a selected host for structured content extraction.

Described below is an example bandit-type approach for focused crawling, in accordance with an embodiment. In an embodiment, individual hosts hεH^{t} may represent a possible arm, or action, that may potentially be selected by a bandit at an iteration t. Individual h may include a list of pages p belonging to a host. An action aₜεA may be specified as a selection of host hεH^{t} based at least partially on an estimated parameter θₕ at a given time t and for a given A.

In the discussion that follows, an embodiment of an example approach and of various example operations to compute a score s(h) are provided, and the follow notation is utilized simply for convenience: s(h) comprises a score for host h (also referred to in bandit notation as expected reward E(r|a,θ)); C_{all,h} comprises a set of pages of h, which have previously been crawled; C_{good,h} comprises a set of pages of h belonging to a target class, which have been previously been crawled; C_{bad,h} comprises a set of pages of h not belonging to a target class, which have been previously been crawled; Rₕ^{t} comprises a set of pages of h that previously were discovered but not yet crawled at iteration t, meaning that Rₕ^{t}, comprises a portion of a set of pages in a bandit representing h; and pred(p) comprises a confidence value p belonging to a target class based at least partially on a classification approach utilized during crawling operations.

In an embodiment, newly discovered pages may be grouped into respective corresponding hosts. To select a new page, a bandit (e.g., bandit-type) approach may be utilized to identify a host of a page, such as, for example, selecting a host with a relatively high score (e.g., confidence level) and/or selecting a host at random (depending at least partially on a value of λₜ). From a selected host, a page may be selected based at least in part on a relatively high confidence level for a target class, such as a confidence level of 80% as a non-limiting example. A process as specified below, designated here as process 1, provides an example for focused crawling with a linearly decaying factor, although this is merely an illustration of a possible embodiment and is not meant to limit claimed subject matter:

```
Initial back-off probability λ, initial seed set Rₕ, decaying factor m.
λₜ, ← λ, C_{bad,h} ← Ø, C_{good,h} ← Ø, ∀h ε Rₕ
for t ← 1 to T do
  Draw uniformly a random number n = ε [0. . . 1]
  if n > λₜ then
    for h ε H^{t} do
      if |Rₕ^{t}| > 0 then
        Compute score s(h)
      end
      Select host h = argmax_{hεHt} s(h)
  else
    Select a random host h where |Rₕ^{t}| > 0
  end
  p ← h = argmax_{p′εRh} pred(p′)
  crawl p and observe reward r_{a,t}
  if rₕ = 1 then
    add p to C_{good,h}
  else
    add p to C_{bad,h}
  end
  update H and Rₕ with new p, h retrieved from p
  for ∀ new h do
    C_{bad,h} ← Ø, C_{good,h} ← Ø
  end
  ${λ}_{t} ← λ \cdot \frac{m}{t + m}$
end
```

Example embodiments may utilize any of several example operations related to computing a score s(h). It is noted that operation names, discussed below, are not intended to be limiting in this context and are provided simply for ease of discussion. For example, a ‘Negative Absolute Bad’ operation, s(h)=−|C_{bad,h}|, may be specified, wherein a score of a host may comprise a negative count of previously crawled pages not belonging to a target class of a host. Also, a ‘Best Score’ operation, s(h)=max_{pEh}pred(p)∀pεRₕ, may be specified, wherein a score of a host may be based at least in part on a confidence value of a page of a target class. A ‘Success Rate’ operation s(h)(C_{good,h}+α)/(C_{bad,h}+β), may be specified wherein a score of a host may be based at least in part on a ratio between a count of pages crawled belonging to a target class and a count of pages crawled not belonging to a target class. In an embodiment, initially, a ratio may have previously specified parameters α and β set to “1”.

Additionally, a Thompson Sampling operation, s(h)=Beta(C_{good,h}+α, C_{bad,h}+β), may be specified wherein a score of a host may comprise a random sample value drawn from a beta-distribution with previously specified parameters α and β. A Thompson Sampling operation may be based at least partially on a K-armed Bernoulli bandit-type approach, in an embodiment. The example process, process 1, specified above, may comprise an illustrative example consistent with employing such an approach, although claimed subject matter is not limited in scope to examples provided as illustrations, of course. In another embodiment, an ‘Absolute Good—Best Score’ operation may be specified wherein a score may comprise a product of an absolute count of already crawled relevant pages. Further, a ‘Thompson Sampling—Best Score’ operation may comprise a product of a Thompson Sampling operation value and a Best Score operation value, in an embodiment. Additionally, a ‘Success Rate—Best Score’ operation may comprise a product of a ‘Success Rate’ operation value and a ‘Best Score’ operation value, in an embodiment. Of course, these are merely example illustrative examples.

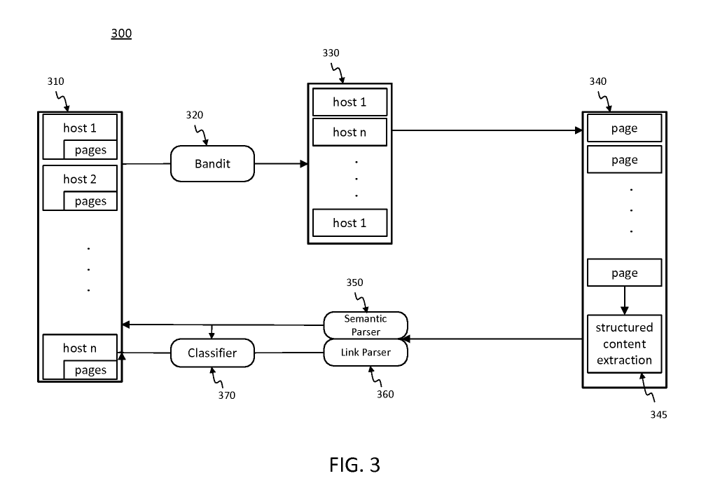

FIG. 3 is a schematic diagram illustrating an example embodiment 300 of a process for focused Web crawling for structured content. In an embodiment, an example focused crawling process may commence with an initial number of seed pages that may be fed to an input queue 310. A URL input handler may obtain a first page from input queue 310, and a classifier 370 may classify a first page and it may be placed in a host queue 330. In an embodiment, classifier 370 may comprise an online classifier, as explained in more detail above, for example. In an embodiment, classifier 370 may begin ‘empty’ (e.g., with no training pages initially available). Also in an embodiment, an example bandit-type process 320 may select a host based at least partially on a given relevancy, value score s(h) and/or decaying factor λ. A selected host may be inserted into host queue 330, and hosts stored in queue 330 may be evaluated to select URLs corresponding to pages with relatively high confidence for respective target classes, such as, for example, a confidence of 80%, although claimed subject matter is not limited in scope in this respect. Also, in an embodiment, pages corresponding to selected URLs with a relatively high confidence for a target class may be ‘pushed’ onto crawler queue 340.

At least in part in response to pages being pushed onto crawler queue 340, additional crawling operations may be performed on pages that may be stored, in an embodiment. For example, structured content, such as previously described, may be extracted from Web pages stored at queue 340, as depicted at block 345. Also, in an embodiment, a semantic parser 350 and/or a link parser 360 may parse pages stored in queue 340 at least in part to generate tokens and/or other features that may be utilized to train classifier 370 and/or to be utilized by a bandit 320, for example. As used herein, the term “semantic parser” may refer to an operation to mapping a natural-language expression into digital content, such as, for example, tokens and/or features, representative of the expression's meaning, in an embodiment. Also, the term “link parser” may refer to an operation to extract links to one or more Web pages from an electronic document, such as an HTML-coded Web page, for example.

For example embodiment 300, system components, such as bandit 320, classifier 370, and/or extraction component 345 may operate at least in part independently, and/or may also operate at different speeds. In an embodiment, it may be desirable to reduce risk of crawler queue 340 becoming empty and waiting for new pages. Additionally, in an embodiment, provisions may be made to delay bandit 320 in response to an indication that extraction component 345 is busy and/or that queue 340 is full so as to reduce risk of a delay in bandit 320 receiving feedback for action aₜ (e.g., as a score for action aₜ₊₁ is calculated).

Table 1, below, depicts example test results for various example embodiments of processes for crawling Web pages, such as previously described.

TABLE 1

| | Percentage of |
|---|---|
| Selection Strategy | Relevant Pages |
| Random | 0.159 |
| BFS | 0.291 |
| Naïve Bayes (100k Training Set) | 0.312 |
| Naïve Bayes (250k Training Set) | 0.316 |
| Naïve Bayes (1000k Training Set) | 0.311 |
| Naïve Bayes (Online) | 0.534 |
| HoeffdingTree (100k Training Set) | 0.408 |
| HoeffdingTree (250k Training Set) | 0.381 |
| HoeffdingTree (1000k Training Set) | 0.482 |
| HoeffdingTree (Online) | 0.512 |
| Thompson Sampling (λ = 0.0) | 0.452 |
| Thompson Sampling • Best Score (λ = 0.0) | 0.562 |
| Negative Absolute Bad (λ = 0.0) | 0.300 |
| Absolute Good • Best Score (λ = 0.0) | 0.589 |
| Success Rate (λ = 0.0) | 0.628 |
| Success Rate • Best Score (λ = 0.0) | 0.550 |
| Success Rate (λ = 0.1) | 0.628 |
| Success Rate (λ = 0.2) | 0.600 |
| Absolute Good • Best Score (λ = 0.1) | 0.558 |
| Absolute Good • Best Score (λ = 0.2) | 0.590 |
| Success Rate (decaying λₜ = 0.2) | 0.662 |
| Success Rate (decaying λₜ = 0.5) | 0.673 |

As described above, example embodiments may comprise focused Web page crawling for structured content, including embodiments employing bandit-type host selection and/or online classification, so that as Web crawler may tend towards locating more relevant pages. Experimental results for example embodiments of focused crawling for structured content, such as shown in Table 1, for example, appear to indicate that use of online classification may result in an improvement of approximately 10% or higher in terms of crawling relevant pages compared with conventional approaches. Additionally, example test results appear to show an improvement of approximately 26% in terms of crawling relevant pages by utilizing bandit-type selection in comparison to approaches utilizing online classification without bandit-type selection.

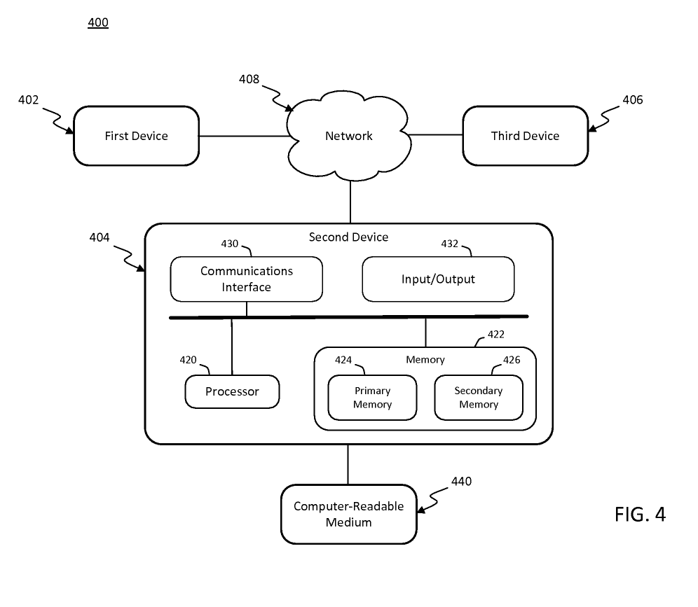

For purposes of illustration, FIG. 4 is an illustration of an embodiment of a system 400 that may be employed in a client-server type interaction, such as described infra. in connection with rendering a GUI via a device, such as a network device and/or a computing device, for example. In FIG. 4, computing device 402 (‘first device’ in figure) may interface with client 404 (‘second device’ in figure), which may comprise features of a client computing device, for example. Communications interface 430, processor (e.g., processing unit) 420, and memory 422, which may comprise primary memory 424 and secondary memory 426, may communicate by way of a communication bus, for example. In FIG. 1, client computing device 402 may represent one or more sources of analog, uncompressed digital, lossless compressed digital, and/or lossy compressed digital formats for content of various types, such as video, imaging, text, audio, etc. in the form physical states and/or signals, for example. Client computing device 402 may communicate with computing device 404 by way of a connection, such as an internet connection, via network 408, for example. Although computing device 404 of FIG. 1 shows the above-identified components, claimed subject matter is not limited to computing devices having only these components as other implementations may include alternative arrangements that may comprise additional components or fewer components, such as components that function differently while achieving similar results. Rather, examples are provided merely as illustrations. It is not intended that claimed subject matter to limited in scope to illustrative examples.

Processor 420 may be representative of one or more circuits, such as digital circuits, to perform at least a portion of a computing procedure and/or process. By way of example, but not limitation, processor 420 may comprise one or more processors, such as controllers, microprocessors, microcontrollers, application specific integrated circuits, digital signal processors, programmable logic devices, field programmable gate arrays, the like, or any combination thereof. In implementations, processor 420 may perform signal processing to manipulate signals and/or states, to construct signals and/or states, etc., for example.

Memory 422 may be representative of any storage mechanism. Memory 422 may comprise, for example, primary memory 424 and secondary memory 426, additional memory circuits, mechanisms, or combinations thereof may be used. Memory 422 may comprise, for example, random access memory, read only memory, etc., such as in the form of one or more storage devices and/or systems, such as, for example, a disk drive, an optical disc drive, a tape drive, a solid-state memory drive, etc., just to name a few examples. Memory 422 may be utilized to store a program. Memory 422 may also comprise a memory controller for accessing computer readable-medium 440 that may carry and/or make accessible content, which may include code, and/or instructions, for example, executable by processor 420 and/or some other unit, such as a controller and/or processor, capable of executing instructions, for example.

Under direction of processor 420, memory, such as memory cells storing physical states, representing, for example, a program, may be executed by processor 420 and generated signals may be transmitted via the Internet, for example. Processor 420 may also receive digitally-encoded signals from client computing device 402.

Network 408 may comprise one or more network communication links, processes, services, applications and/or resources to support exchanging communication signals between a client computing device, such as 402, and computing device 406 (‘third device’ in figure), which may, for example, comprise one or more servers (not shown). By way of example, but not limitation, network 408 may comprise wireless and/or wired communication links, telephone and/or telecommunications systems, Wi-Fi networks, Wi-MAX networks, the Internet, a local area network (LAN), a wide area network (WAN), or any combinations thereof.

The term “computing device,” as used herein, refers to a system and/or a device, such as a computing apparatus, that includes a capability to process (e.g., perform computations) and/or store content, such as measurements, text, images, video, audio, etc. in the form of signals and/or states. Thus, a computing device, in this context, may comprise hardware, software, firmware, or any combination thereof (other than software per se). Computing device 404, as depicted in FIG. 1, is merely one example, and claimed subject matter is not limited in scope to this particular example. For one or more embodiments, a computing device may comprise any of a wide range of digital electronic devices, including, but not limited to, personal desktop and/or notebook computers, high-definition televisions, digital versatile disc (DVD) players and/or recorders, game consoles, satellite television receivers, cellular telephones, wearable devices, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 422 may store cookies relating to one or more users and may also comprise a computer-readable medium that may carry and/or make accessible content, including code and/or instructions, for example, executable by processor 420 and/or some other unit, such as a controller and/or processor, capable of executing instructions, for example. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

Regarding aspects related to a communications and/or computing network, a wireless network may couple client devices with a network. A wireless network may employ stand-alone ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including Long Term Evolution (LTE), WLAN, Wireless Router (WR) mesh, 2nd, 3rd, or 4th generation (2G, 3G, or 4G) cellular technology and/or the like. Network access technologies may enable wide area coverage for devices, such as client devices with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra wideband (UWB), 802.11b/g/n, and/or the like. A wireless network may include virtually any type of now known and/or to be developed wireless communication mechanism by which signals may be communicated between devices, between networks, within a network, and/or the like.

Communications between a computing device and/or a network device and a wireless network may be in accordance with known and/or to be developed communication network protocols including, for example, global system for mobile communications (GSM), enhanced data rate for GSM evolution (EDGE), 802.11b/g/n, and/or worldwide interoperability for microwave access (WiMAX). A computing device and/or a networking device may also have a subscriber identity module (SIM) card, which, for example, may comprise a detachable smart card that is able to store subscription content of a user, and/or is also able to store a contact list of the user. A user may own the computing device and/or networking device or may otherwise be a user, such as a primary user, for example. A computing device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a communication network may be embodied as a wired network, wireless network, or any combinations thereof.

A device, such as a computing and/or networking device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

A computing and/or network device may include and/or may execute a variety of now known and/or to be developed operating systems, derivatives and/or versions thereof, including personal computer operating systems, such as a Windows, iOS, Linux, a mobile operating system, such as iOS, Android, Windows Mobile, and/or the like. A computing device and/or network device may include and/or may execute a variety of possible applications, such as a client software application enabling communication with other devices, such as communicating one or more messages, such as via protocols suitable for transmission of email, short message service (SMS), and/or multimedia message service (MMS), including via a network, such as a social network including, but not limited to, Facebook, LinkedIn, Twitter, Flickr, and/or Google+, to provide only a few examples. A computing and/or network device may also include and/or execute a software application to communicate content, such as, for example, textual content, multimedia content, and/or the like. A computing and/or network device may also include and/or execute a software application to perform a variety of possible tasks, such as browsing, searching, playing various forms of content, including locally stored and/or streamed video, and/or games such as, but not limited to, fantasy sports leagues. The foregoing is provided merely to illustrate that claimed subject matter is intended to include a wide range of possible features and/or capabilities.

A network may also be extended to another device communicating as part of another network, such as via a virtual private network (VPN). To support a VPN, broadcast domain signal transmissions may be forwarded to the VPN device via another network. For example, a software tunnel may be created between a logical broadcast domain, and a VPN device. Tunneled traffic may, or may not be encrypted, and a tunneling protocol may be substantially compliant with and/or substantially compatible with any now known and/or to be developed versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, another existing protocol, and/or another protocol that may be developed.

A network may communicate via signal packets and/or frames, such as in a network of participating digital communications. A broadcast domain may be compliant and/or compatible with, but is not limited to, now known and/or to be developed versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A broadcast domain may employ, for example, TCP/IP, UDP, DECnet, NetBEUI, IPX, Appletalk, other, and/or the like. Versions of the Internet Protocol (IP) may include IPv4, IPv6, other, and/or the like.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method, comprising:
crawling a plurality of Web pages to extract structured content utilizing, at least in part, a processor of a computing device, wherein the structured content is embedded in the plurality of Web pages using one or more markup languages.

2. The method of claim 1, wherein the structured content comprises semantic content, and wherein said crawling the plurality of Web pages comprises crawling the plurality Web pages focusing on the semantic content.

3. The method of claim 1, wherein said crawling the plurality of Web pages comprises performing an online classification of the plurality of Web pages to identify, at least in part, one or more Web pages for content extraction.

4. The method of claim 3, wherein said performing the online classification comprises determining which of the plurality of Web pages has structured content embedded therein.

5. The method of claim 3, the online classification to identify the one or more Web pages for extraction based, at least in part, on one or more specified markup languages utilized to embed structured content in the one or more Web pages.

6. The method of claim 1, wherein said crawling the plurality of Web pages comprises performing a bandit-type selection of the plurality of Web pages to identify, at least in part, one or more Web pages for content extraction.

7. The method of claim 1, wherein said crawling the plurality of Web pages comprises:
selecting a host computing platform having stored therein a subset of the plurality of Web pages; and
selecting one or more Web pages from the subset of Web pages stored at the host computing platform utilizing, at least in part, an online classification process.

8. The method of claim 7, wherein said selecting the host computing platform comprises performing a bandit-type selection operation.

9. The method of claim 8, wherein said performing the bandit-type selection operation comprises determining an estimated relevance for the subset of Web pages stored at the host computing platform.

10. An apparatus, comprising: a processor to:
crawl a plurality of Web pages to extract structured content, wherein the structured content is embedded in the plurality of Web pages using one or more markup languages.

11. The apparatus of claim 10, wherein the structured content comprises semantic content, the processor further to crawl the plurality of Web pages focusing on the semantic content.

12. The apparatus of claim 10, wherein the structured content comprises semantic content, the processor further to perform an online classification of the plurality of Web pages to identify, at least in part, one or more Web pages for content extraction to crawl the plurality of Web pages.

13. The apparatus of claim 12, the processor further to determine which of the plurality of Web pages has structured content embedded therein to perform the online classification.

14. The apparatus of claim 12, the processor to perform the online classification to identify the one or more Web pages for extraction based, at least in part, on one or more specified markup languages utilized to embed structured content in the one or more Web pages.

15. The apparatus of claim 10, the processor further to perform a bandit-type selection of the plurality of Web pages to identify, at least in part, one or more Web pages for content extraction to crawl the plurality of Web pages.

16. The apparatus of claim 10, wherein, to crawl the plurality of Web pages, the processor to:
select a host computing platform having stored therein a subset of the plurality of Web pages; and
select one or more Web pages from the subset of Web pages stored at the host computing platform utilizing, at least in part, an online classification process.

17. The apparatus of claim 16, the processor further to perform a bandit-type selection operation to select the host computing platform.

18. The apparatus of claim 17, the processor further to determine an estimated relevance for the subset of Web pages stored at the host computing platform to perform the bandit-type selection operation.

19. An apparatus, comprising:
means for crawling a plurality of Web pages to extract structured content, wherein the structured content is embedded in the plurality of Web pages using one or more markup languages.

20. The apparatus of claim 19, wherein the structured content comprises semantic content, and wherein said means for crawling the plurality of Web pages comprises means for crawling the plurality Web pages focusing on the semantic content.

21. The apparatus of claim 19, wherein said means for crawling the plurality of Web pages comprises means for performing an online classification of the plurality of Web pages to identify, at least in part, one or more Web pages for content extraction.

22. The apparatus of claim 21, wherein said means for performing the online classification comprises means for determining which of the plurality of Web pages has structured content embedded therein.

23. The apparatus of claim 21, the online classification to identify the one or more Web pages for extraction based, at least in part, on one or more specified markup languages utilized to embed structured content in the one or more Web pages.

24. The apparatus of claim 19, wherein said means for crawling the plurality of Web pages comprises means for performing a bandit-type selection of the plurality of Web pages to identify, at least in part, one or more Web pages for content extraction.

25. The apparatus of claim 19, wherein said means for crawling the plurality of Web pages comprises:
means for selecting a host computing platform having stored therein a subset of the plurality of Web pages; and
means for selecting one or more Web pages from the subset of Web pages stored at the host computing platform utilizing, at least in part, an online classification process.

26. The apparatus of claim 25, wherein said means for selecting the host computing platform comprises means for performing a bandit-type selection operation.

27. The apparatus of claim 26, wherein said means for performing the bandit-type selection operation comprises means for determining an estimated relevance for the subset of Web pages stored at the host computing platform.
